(19) United States
(12) Patent Application Publication
(10) Pub. No.: US 2012/0239705 A1
(43) Pub. Date: Sep. 20, 2012

(54) MOBILE INFORMATION SYSTEM FOR 12-LEAD ECG

(75) Inventors: JUI-CHIEN HSIEH, Taoyuan County (TW); TING-HSUN SHEN, Taoyuan County (TW); HSIU-CHIUNG LO, Taoyuan County (TW); BO-YI GU, Taoyuan County (TW); PEI-CHANN CHANG, Taoyuan County (TW)

(73) Assignee: YUAN ZE UNIVERSITY, Taoyuan County (TW)

(21) Appl. No.: 13/401,448

(22) Filed: Feb. 21, 2012

(30) Foreign Application Priority Data
Mar. 18, 2011 (TW) 100109402

(51) Int. Cl. G06F 17/30; G06F 15/16

(52) U.S. Cl. 707/803; 707/E17.005

(57) ABSTRACT

The present invention is different to the existing 12-leads electrocardiogram mobile information system which could only provide the inquiring service to specific smart phone operation system, and designed using the network service as the platform for data transforming and communications of the programs between the mobile-end and the server-end. The different kinds of databases (eg, SQL SERVER [symbol] MYSQL) are then transformed to same kind SQLITE database according to the property of the SQLITE database supporting many kinds of operation, so as to provide services to smart phones using many different kinds of operation systems, and achieve the goal to integrate the mobile database of 12-leads electrocardiogram.

### FIELD OF THE INVENTION

The present invention relates to a mobile information system for 12-lead electrocardiogram (ECG).

### DESCRIPTION OF PRIOR ART

The present research of the 12-leads electrocardiogram applicable to a telemedicine system, such as Taiwan patent published number M349259, reveals that the system is constructed in a WINDOWS operation system environment. An SQL server is used as the server-end of the data base of the medical information system, and a WINDOWS MOBILE data base is used as the mobile-end. The proxy of the server-end of the data base provided by Microsoft is used as the intermediary by both ends, and thus the mobile apparatus using WINDOWS MOBILE operation could obtain a report of 12-leads electrocardiogram through the wireless network function of a mobile phone. However, this kind of structure is limited to the systems and data bases of WINDOWS, it could only serve for the mobile-end which uses the WINDOWS MOBILE operation, and it can not provide service to the mobile phones using other operation systems. Such are drawbacks of the existing technology.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a structure diagram of the present invention.

FIG. 2 illustrates a flow chart of the function of the mobile-end device of the present invention.

FIG. 3 illustrates a flow chart of the function of the intermediary program of the present invention.

FIG. 4 illustrates an image of the query result of the present invention.

### SUMMARY OF THE INVENTION

The present invention discloses a 12-leads electrocardiograph mobile information system, which comprises: a mobile-end device for receiving electrocardiograph-related data; a server-end device, comprising a data base for saving the electrocardiograph-related data; an intermediary program server being a network server for processing or interchanging the electrocardiograph-related data of the mobile-end device or the server-end device, in which the server-end device manipulates or responses the intermediary program server.

### DETAILED DESCRIPTION OF THE INVENTION

The present invention is different to the existing 12-leads electrocardiogram mobile information system which could only provide the inquiring service to a specific smart phone operation system, and is designed using the network service as the platform for data transforming and communications of the programs between the mobile-end and the server-end. The different kinds of databases (eg, SQL SERVER [symbol] MYSQL) are then transformed to a same kind SQLITE database according to the property of the SQLITE database for supporting many kinds of operations, so as to provide services to a smart phone using many different kinds of operation systems, and achieve the goal to integrate the mobile database of 12-leads electrocardiogram.

The present invention discloses a 12-leads electrocardiograph mobile information system, which comprises: a mobile-end device for receiving electrocardiograph-related data; a server-end device, comprising a data base for saving the electrocardiograph-related data, and the electrocardiograph-related data can be from a hospital medical information system; an intermediary program server, being a network server for processing or interchanging the electrocardiograph-related data of the mobile-end device or the server-end device, in which the server-end device manipulates or responses the intermediary program server; and a data base device for transforming the electrocardiograph-related data with different kinds of format onto the data base device. Wherein, a file format of the data base device is an SQLite data base format, which is compatible with a plurality of heterogonous mobile-end devices (being an iOS operating system, RIM operating system or Android operating system) or a plurality of heterogonous server-end devices (being an Windows operating system or Linux operating system). The database used by the Windows operating device makes use of SQL, MySQL or Oracle, and the database used by the Linux operating device makes use of MySQL.

The intermediary program server of the present invention could execute: a network service function, for receiving a command of the mobile-end device and then reading the electrocardiograph-related data from the server-end system, and then transforming the electrocardiograph-related data to generate a file of the data base device; and a file transferring function, for transferring a file of the data base device to the mobile-end device. Wherein, the data transforming is to transform the data of different kinds data bases (eg: SQL Server or MySQL) of the medical information system to the SQLITE data base.

The steps of the intermediary program server for executing the command of calling the mobile-end comprise: (I) connecting the server-end database device; (II) querying data; (III) transforming the data into the SQLITE data base; (IV) data transferring service.

The mobile-end device, the intermediary program server or the server-end device transfer data via a network.

Through providing the property of the network service that could integrate operation systems, the present invention is designed using the network service as a platform for data transforming and communications of programs between the mobile-end and the server-end, and different kinds of databases (eg, SQL SERVER [symbol] MYSQL) are then transformed to a same kind SQLITE database according to the property of the SQLITE database for supporting many kinds of operation, so as to provide services to smart phones using many different kinds of operation systems. Through the wireless internet function via a mobile phone, the 12-leads electrocardiograph reports could be queried and obtained from the data base of the hospital medical information system.

With these and other objects, advantages, and features of the invention that may become hereinafter apparent, the nature of the invention may be more clearly understood by reference to the detailed description of the invention, the embodiments and to the several drawings herein.

### EXAMPLE

Exemplary embodiments of the present invention are described herein in the context of an illuminating system and a method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

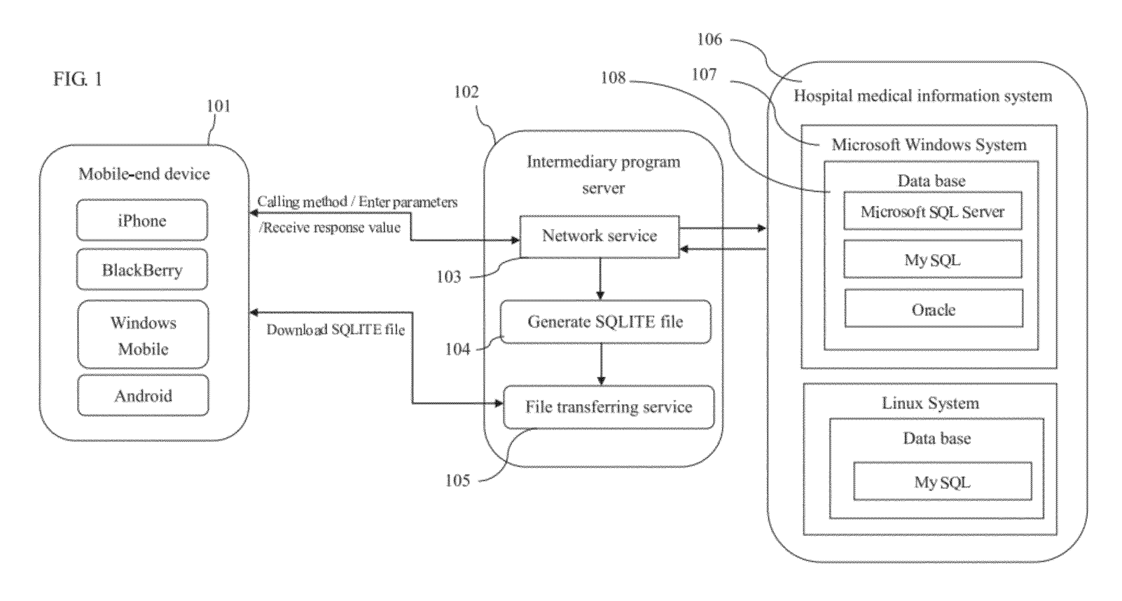

Please refer to FIG. 1. The present invention could enable the mobile-ends device 101 to use different operation systems to access different kinds of data bases 108 of a hospital medical information system 106, MICROSOFT WINDOWS system 107 or LUNUX system by an intermediary program server 102 for manipulating the systems using Network Service 103. An SQLITE file 104 was generated and stored in the SQLITE data base after the data formats of different data bases being processed by the intermediary program server. Through a file transferring service 105, a user could obtain a patient's 12-leads electrocardiograph report immediately using a mobile phone having a wireless internet function of a mobile phone.

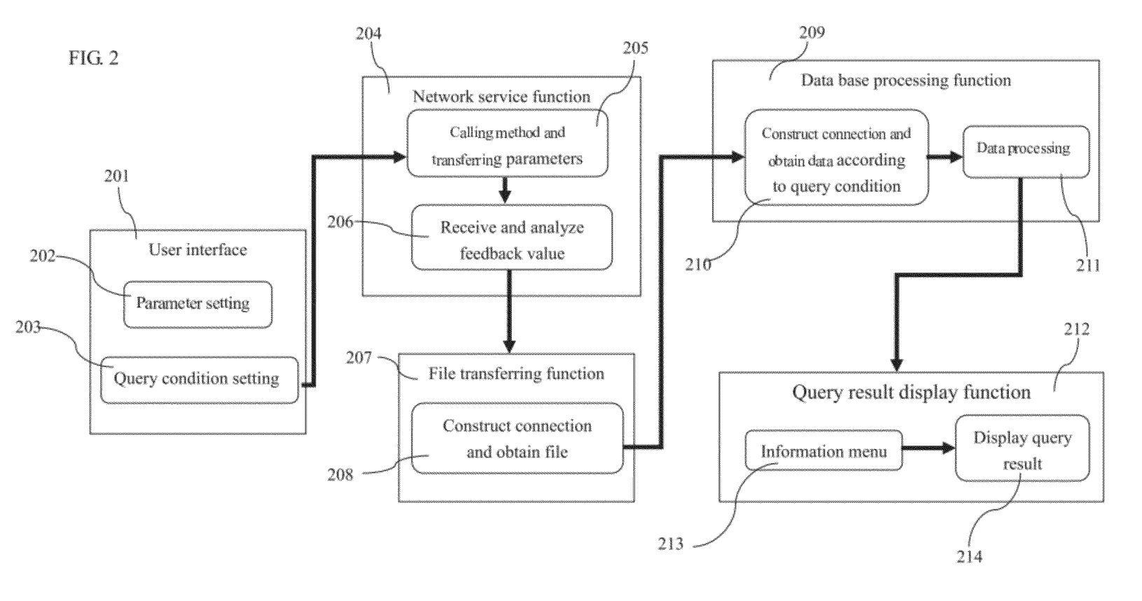

In the present invention, a flow of the user for manipulating the intermediary program server was shown in FIG. 2. First, the medical personnel used the smart phone (mobile-end system) provided by the present invention to enter a user interface 201, and after parameter setting 202 and query condition setting 203, a network service function 204 called the network service and transferring parameters 205 through the wireless internet of the smart phone. After four parameters (account, password, SQL command, and file name) were transferred, a next stop was to receive and analyze the feedback value provided by a network service 206, wherein the feedback value defined the processing result of the network service. If the query was failed, related messages were displayed to remind the user and it would return to the beginning user interface. If the query was successful, a file transferring function 207 would be started, and the communication would be constructed to obtain file 208. Then, a data base processing function 209 started to construct the connecting to the SQLITE data base to obtain data 210 and then to execute a data processing 211. Finally, information menu 213 of a query result display function 212 was provided to the user to view each query result 214.

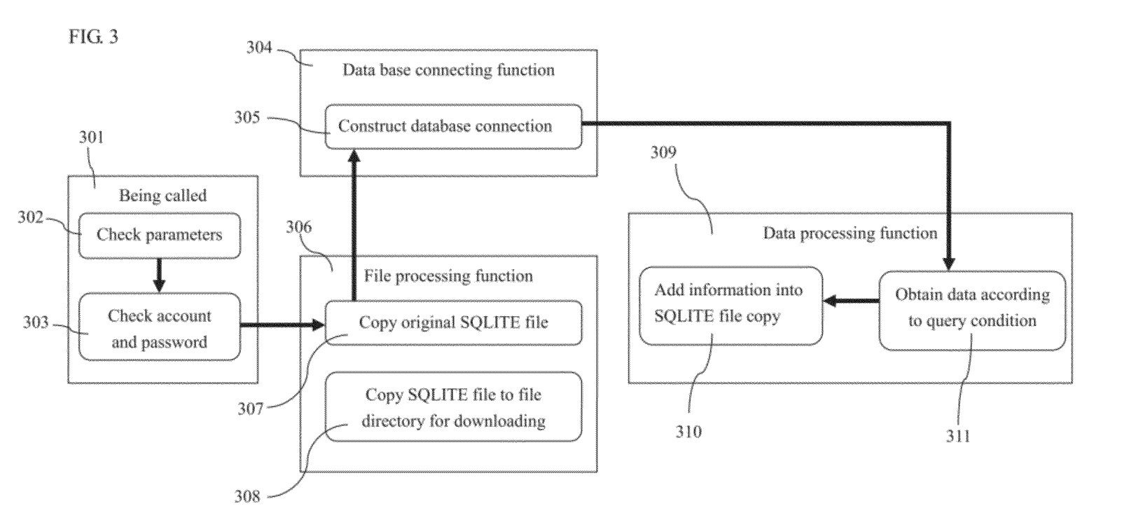

Please refer to FIG. 3. The main function of the intermediary program server of the present invention was to provide the medical personnel to remotely obtain the patient's electrocardiograph data from the hospital medical information system through the network service function by using the wireless internet function of the smart phone. The processing steps of the intermediary program server would be described as follows.

Step 1: The intermediary program server was being called 301 and it was to determine whether the format of parameters 302 was correct or not, so as to avoid the serer being used by an un-licensed person. After verification 303, an original SQLITE file 307 was copied by a file processing function 306, and the copy file was provided to be used in this connection so as to avoid the original SQLITE file being locked that caused another on-line user not able to operate the server normally.
Step 2: It was to construct a connection 305 between the SQLITE data base of the intermediary program server and the data base of the hospital medical information system 305 via a data base connecting function 304.
Step 3: It was to obtain a data base information 311 through data processing function 309 according to the SQL command and the query condition transferred into the hospital medical information system, and then to transform and add the information into SQLITE file 310 copy.
Step 4: It was to copy the modified SQLITE file to file directory 308 to provide downloading for the smart phone.

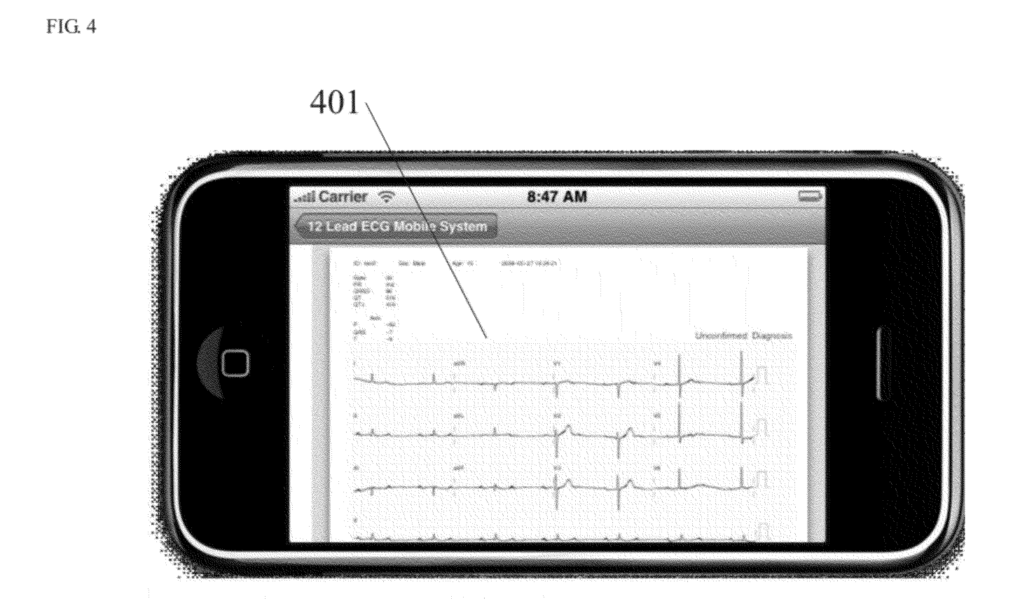

Please refer to FIG. 4. The IPHONE 3G was used as to implement the present invention. After obtaining the query data from the data base by the intermediary program server, the electrocardiograph was displayed on a screen 401. The multi-touch control technique and the high resolution LCD of the IPHONE 3G could provide the user with excellent picture viewing experience.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A 12-leads electrocardiograph mobile information system, comprising:
a mobile-end device for receiving electrocardiograph-related data;
a server-end device comprising a data base for saving the electrocardiograph-related data; and
an intermediary program server, being a network server for processing or interchanging the electrocardiograph-related data of the mobile-end device or the server-end device, in which the server-end device manipulates or responses the intermediary program server.

2. The 12-leads electrocardiograph mobile information system of claim 1, further comprising a data base device for transforming the electrocardiograph-related data with different kinds of format onto the data base device.

3. The 12-leads electrocardiograph mobile information system of claim 2, wherein a file format of the data base device is an SQLite data base format.

4. The 12-leads electrocardiograph mobile information system of claim 3, wherein the SQLite data base format is compatible with a plurality of heterogonous mobile-end devices or a plurality of heterogonous server-end devices.

5. The 12-leads electrocardiograph mobile information system of claim 1, wherein the intermediary program server could execute:
a network service function, for receiving a command of the mobile-end device and then reading the electrocardiograph-related data from the server-end device, and then transforming the electrocardiograph-related data to generate a file of the data base device; and
a file transferring function, for transferring the file of the data base device to the mobile-end device.

6. The 12-leads electrocardiograph mobile information system of claim 4, wherein the heterogonous mobile-end device is a Windows Mobile operating device, iOS operating device, RIM operating device or Android operating device.

7. The 12-leads electrocardiograph mobile information system of claim 4, wherein the heterogonous server-end device is a Windows operating device, Mac operating device or Linux operating device.

8. The 12-leads electrocardiograph mobile information system of claim 7, wherein a database used by the Windows operating device makes use of SQL, MySQL or Oracle.

9. The 12-leads electrocardiograph mobile information system of claim 7, wherein a database used by the Linux operating device makes use of MySQL.

10. The 12-leads electrocardiograph mobile information system of claim 1, which is used to transfer the electrocardiograph-related data via a network.
